(19) United States
(12) Patent Application Publication
(10) Pub. No.: US 2021/0050619 A1
(43) Pub. Date: Feb. 18, 2021

(54) LITHIUM OXIDE CO-MODIFIER TO ENHANCE THE AIR STABILITY OF SULFIDE AND OXYSULFIDE GLASS AND GLASS-CERAMIC SOLID-STATE ELECTROLYTES

(71) Applicant: GM GLOBAL TECHNOLOGY OPERATIONS LLC, Detroit, MI (US)

(72) Inventors: Thomas A. YERSAK, Ferndale, MI (US); James R. SALVADOR, Royal Oak, MI (US)

(73) Assignee: GM GLOBAL TECHNOLOGY OPERATIONS LLC, Detroit, MI (US)

(21) Appl. No.: 16/538,353

(22) Filed: Aug. 12, 2019

(51) Int. Cl. H01M 10/0562

(52) U.S. Cl. CPC H01M 10/0562; H01M 2300/0091; H01M 2300/0068

(57) ABSTRACT

A solid-state electrolyte is provided. The solid-state electrolyte includes an integrated molecular network that results from a mixture including a glass former including sulfur, a glass modifier including sulfur, and a glass co-modifier including lithium oxide or sodium oxide. The solid-state electrolyte is substantially resistant to hydrolysis in an atmosphere having a dew point of greater than about −90° C. Methods of making the solid-state electrolyte are also provided.

### INTRODUCTION

This section provides background information related to the present disclosure which is not necessarily prior art.

Electrochemical energy storage devices, such as lithium-ion batteries, can be used in a variety of products, including automotive products, such as start-stop systems (e.g., 12V start-stop systems), battery-assisted systems (“μBAS”), Hybrid Electric Vehicles (“HEVs”), and Electric Vehicles (“EVs”). Typical lithium-ion batteries include two electrodes, a separator, and an electrolyte. Lithium-ion batteries may also include various terminal and packaging materials. One of the two electrodes serves as a positive electrode or cathode, and the other electrode serves as a negative electrode or anode. Conventional rechargeable lithium-ion batteries operate by reversibly passing lithium ions back and forth between the negative electrode and the positive electrode. For example, lithium ions may move from the positive electrode to the negative electrode during charging of the battery and in the opposite direction when discharging the battery. A separator and/or electrolyte may be disposed between the negative and positive electrodes. The electrolyte is suitable for conducting lithium ions (or sodium ions in the case of sodium-ion batteries) between the electrodes and, like the two electrodes, may be in a solid form, a liquid form, or a solid-liquid hybrid form. In the instances of solid-state batteries, which include a solid-state electrolyte disposed between solid-state electrodes, the solid-state electrolyte physically separates the electrodes so that a distinct separator is not required.

Solid-state batteries have advantages over batteries that include a separator and a liquid electrolyte. These advantages include a longer shelf life with lower self-discharge, simpler thermal management systems, a reduced need for packaging, and the ability to operate at a higher energy density within a wider temperature window.

Many prototypical solid-state batteries have a sulfide-based (including oxysulfide-based) solid-state electrolyte. Such solid-state electrolytes have an integrated molecular network in which some sulfur molecules, especially at the surfaces, are subject to react with atmospheric water and hydrolyze into H₂S. To avoid or minimize this hydrolysis, solid-state battery processing may be performed in dry conditions with low humidity, such as in an inert glovebox having a dew point of about −90° C. (about 0.1 ppm H₂O) or a relative humidity at 70° F. of 0.00037%. Accordingly, sulfur-based solid-state electrolyte materials that have a lower tendency to hydrolyze are desired.

### SUMMARY

This section provides a general summary of the disclosure, and is not a comprehensive disclosure of its full scope or all of its features.

In various aspects, the current technology provides a solid-state electrolyte including an integrated molecular network resulting from a mixture having a glass former including sulfur, a glass co-former including sulfur, a glass modifier including sulfur, and a glass co-modifier including an oxide, wherein the solid-state electrolyte is substantially resistant to hydrolysis in an atmosphere having a dew point of greater than about −90° C.

In one aspect, the solid-state electrolyte has a glass transition.

In one aspect, the glass former is present in a first concentration range; the glass co-former is present in a second concentration range that is lower than, and non-overlapping with, the first concentration range; the glass former and the glass co-former have a material individually selected from the group including P₂S₅, SiS₂, GeS₂, B₂S₃, Sb₂S₅, and combinations thereof; and the glass former and the glass co-former do not have a material in common.

In one aspect, the mixture further includes a glass dopant selected from the group including MX, M₃PO₄, M₂SiO₃, and combinations thereof, where M is Li or Na, and X is a halogen.

In one aspect, the glass former is selected from the group including P₂S₅, SiS₂, GeS₂, B₂S₃, Sb₂S₅, and combinations thereof; and the mixture further has a glass co-former selected from the group including P₂O₅, SiO₂, GeO₂, and combinations thereof.

In one aspect, the mixture further includes a glass dopant selected from the group including MX, M₃PO₄, M₂SiO₃, and combinations thereof, where M is Li or Na, and X is a halogen.

In one aspect, the glass modifier is M₂S, where M is Li or Na.

In one aspect, the glass co-modifier includes M₂O, where M is Li or Na.

In one aspect, the solid-state electrolyte is in a green form having an interparticle porosity of greater than or equal to about 10 vol. % to less than or equal to about 50 vol. %.

In one aspect, the integrated molecular network is coated with a thermally removable protective sacrificial binder layer.

In one aspect, the solid-state electrolyte is in a consolidated working form having an interparticle porosity of greater than 0 vol. % to less than or equal to about 10 vol. %.

In one aspect, the solid-state electrolyte is incorporated into a solid-state battery.

In various aspects, the current technology also provides a particle having a first component derived from a glass former including sulfur, a second component derived from a glass co-former including sulfur, a third component derived from a glass modifier including sulfur, and a fourth component derived from a glass co-modifier including lithium oxide or sodium oxide, wherein the particle has a glass transition and wherein the particle is substantially resistant to hydrolysis in an atmosphere having a dew point of greater than about −70° C.

In one aspect, the glass former and the glass co-former include a material individually selected from the group including P₂S₅, SiS₂, GeS₂, B₂S₃, Sb₂S₅, and combinations thereof, the glass former and the glass co-former not having a material in common, and the glass former having a higher concentration that the glass co-former; the glass modifier is M₂S, where M is Li or Na; and the glass co-modifier includes M₂O, where M is Li or Na.

In one aspect, the particle further includes a fifth component derived from a glass dopant selected from the group including MX, M₃PO₄, M₂SiO₃, and combinations thereof, where M is Li or Na, and X is a halogen.

In various aspects, the current technology further provides a method of fabricating a solid-state electrolyte, the method including combining a plurality of particles resulting from ball milling or melt quenching a mixture having a glass former including sulfur, a glass modifier including sulfur, and a glass co-modifier including lithium oxide or a sodium oxide in a solvent to form a slurry; and removing the solvent from the slurry to form the solid-state electrolyte in a green state, wherein the method is performed in an atmosphere having a dew point of greater than or equal to about −70° C.

In one aspect, the removing the solvent from the slurry includes heating the slurry to a temperature of greater than or equal to about 20° C. to less than or equal to about 100° C. and optionally applying a negative pressure to the slurry.

In one aspect, the solvent is aprotic and has a kinematic viscosity of less than or equal to about 0.3 mPa·s.

In one aspect, the method further includes hot pressing the solid-state electrolyte in the green state at a temperature of greater than or equal to about 100° C. to less than or equal to about 350° C. to convert the solid-state electrolyte from the green state to a working state having a porosity of less than or equal to about 10%.

In one aspect, prior to the hot pressing, the solid-state electrolyte in the green state is disposed between a cathode and an anode.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an illustration of a solid-state battery in accordance with various aspects of the current technology.

FIG. 2 is an illustration of an all-solid-state metal battery in accordance with various aspects of the current technology.

FIG. 3 is an illustration of a solid-state electrolyte according to various aspects of the current technology.

FIG. 4A shows a reaction for forming a solid-state electrolyte.

FIG. 4B is an illustration of the solid-state electrolyte formed in FIG. 4A.

FIG. 5 is an illustration of a solid-state electrolyte that resists water according to various aspects of the current technology.

FIG. 6 is an illustration of a solid-state electrolyte having a sacrificial coating in accordance with various aspects of the current technology.

FIG. 7 is an illustration of a solid-state electrolyte disposed on a substrate in accordance with various aspects of the current technology.

FIG. 8 is a reaction scheme showing the decomposition of poly(propylene carbonate) (PPC).

FIG. 9 is a graph showing H₂S levels released from a control solid-state electrolyte and a solid-state electrolyte made in accordance with various aspects of the current technology. The y-axis represents H₂S generation with a scale of 0-60 cc of H₂S gas per g of solid-state electrolyte, and the x-axis represents time with a scale of from 0-80 minutes.

FIG. 10 is a graph showing H₂S levels released from a control solid-state electrolyte and a solid-state electrolyte made in accordance with various aspects of the current technology. The y-axis represents H₂S generation with a scale of 0-8 cc of H₂S gas per g of solid-state electrolyte, and the x-axis represents time with a scale of from 0-40 minutes.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

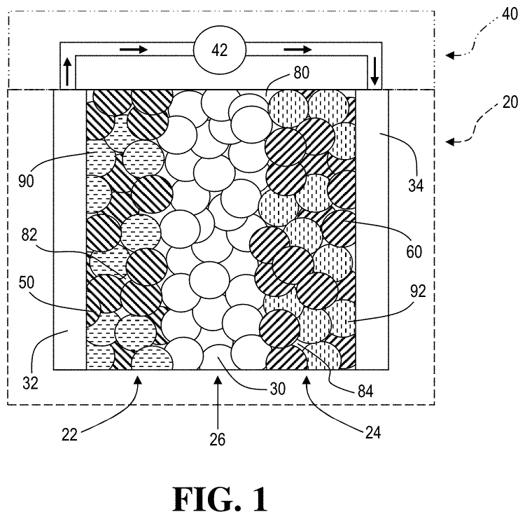

An exemplary and schematic illustration of an all-solid-state electrochemical cell 20 (also referred to herein as “the battery”), i.e., a lithium ion or sodium ion cell, that cycles lithium ions or sodium ions is shown in FIG. 1. Unless specifically indicated otherwise, the term “ions” as used herein refers to lithium ions or sodium ions. The battery 20 includes a negative electrode 22, a positive electrode 24, and a solid-state electrolyte 26 disposed between the electrodes 22, 24. The solid-state electrolyte 26 is both a separator that physically separates the negative electrode 22 from the positive electrode 24 and an ion-conducting electrolyte. The solid-state electrolyte 26 may be defined by a first plurality of solid-state electrolyte particles 30. A second plurality of solid-state electrolyte particles 90 and/or a third plurality of solid-state electrolyte particles 92 may also be mixed with negative solid-state electroactive particles 50 and positive solid-state electroactive particles 60 present in the negative electrode 22 and the positive electrode 24, respectively, to form a continuous solid-state electrolyte network. A negative electrode current collector 32 may be positioned at or near the negative electrode 22, and a positive electrode current collector 34 may be positioned at or near the positive electrode 24. The negative electrode current collector 32 and the positive electrode current collector 34 respectively collect and move free electrons to and from an external circuit 40 (as shown by the block arrows). For example, an interruptible external circuit 40 and a load device 42 may connect the negative electrode 22 (through the negative electrode current collector 32) and the positive electrode 24 (through the positive electrode current collector 34). Composite electrodes can also include an electrically conductive diluent, such as carbon black or carbon nanotubes, that is dispersed throughout materials that define the negative electrode 22 and/or the positive electrode 24.

The battery 20 can generate an electric current (indicated by the block arrows) during discharge by way of reversible electrochemical reactions that occur when the external circuit 40 is closed (to connect the negative electrode 22 and the positive electrode 24) and the negative electrode 22 contains a relatively greater quantity of lithium or sodium. The chemical potential difference between the negative electrode 22 and the positive electrode 24 drives electrons produced by the oxidation of inserted lithium or sodium at the negative electrode 22 through the external circuit 40 towards the positive electrode 24. Ions, which are also produced at the negative electrode 22, are concurrently transferred through the solid-state electrolyte 26 towards the positive electrode 24. The electrons flow through the external circuit 40, and the ions migrate across the solid-state electrolyte 26 to the positive electrode 24 where they may be plated, reacted, or intercalated. The electric current passing through the external circuit 40 can be harnessed and directed through the load device 42 (in the direction of the block arrows) until the lithium or sodium in the negative electrode 22 is depleted and the capacity of the battery 20 is diminished.

The battery 20 can be charged or reenergized at any time by connecting an external power source (e.g., charging device) to the battery 20 to reverse the electrochemical reactions that occur during battery discharge. The connection of the external power source to the battery 20 compels the non-spontaneous oxidation of one or more metal elements at the positive electrode 24 to produce electrons and ions. The electrons, which flow back towards the negative electrode 22 through the external circuit 40, and the ions, which move across the solid-state electrolyte 26 back towards the negative electrode 22, reunite at the negative electrode 22 and replenish it with lithium or sodium for consumption during the next battery discharge cycle. As such, each discharge and charge event is considered to be a cycle, where ions are cycled between the positive electrode 24 and the negative electrode 22.

The external power source that may be used to charge the battery 20 may vary depending on size, construction, and particular end-use of the battery 20. Some notable and exemplary external power sources include, but are not limited to, AC power sources, such as AC wall outlets and motor vehicle alternators. In many of the configurations of the battery 20, each of the negative electrode current collector 32, the negative electrode 22, the solid-state electrolyte 26, the positive electrode 24, and the positive electrode current collector 34 are prepared as relatively thin layers (for example, from several microns to a millimeter or less in thickness) and assembled in layers connected in electrical parallel arrangement to provide a suitable electrical energy and power package. In various other instances, the battery 20 may include electrodes 22, 24 that are connected in series.

Further, in certain aspects, the battery 20 may include a variety of other components that, while not depicted here, are nonetheless known to those of skill in the art. For instance, the battery 20 may include a casing, a gasket, terminal caps, and any other conventional components or materials that may be situated within the battery 20, including between or around the negative electrode 22, the positive electrode 24, and/or the solid-state electrolyte 26, by way of non-limiting example. As noted above, the size and shape of the battery 20 may vary depending on the particular applications for which it is designed. Battery-powered vehicles and hand-held consumer electronic devices are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42.

Accordingly, the battery 20 can generate an electric current to the load device 42 that can be operatively connected to the external circuit 40. The load device 42 may be powered fully or partially by the electric current passing through the external circuit 40 when the battery 20 is discharging. While the load device 42 may be any number of known electrically-powered devices, a few specific examples of power-consuming load devices include an electric motor for a hybrid vehicle or an all-electric vehicle, a laptop computer, a tablet computer, a cellular phone, and cordless power tools or appliances, by way of non-limiting example. The load device 42 may also be a power-generating apparatus that charges the battery 20 for purposes of storing energy.

With further reference to FIG. 1, the solid-state electrolyte 26 provides electrical separation—preventing physical contact—between the negative electrode 22, i.e., an anode, and the positive electrode 24, i.e., a cathode. The solid-state electrolyte 26 also provides a minimal resistance path for internal passage of ions. In various aspects, as noted above, the first plurality of solid-state electrolyte particles 30 may define the solid-state electrolyte 26. For example, the solid-state electrolyte 26 may be in the form of a layer or a composite that comprises the first plurality of solid-state electrolyte particles 30. For example, the solid-state electrolyte 26 may be in the form of a layer having a thickness greater than or equal to about 1 μm to less than or equal to about 1 mm, and in certain aspects, optionally greater than or equal to about 1 μm to less than or equal to about 100 μm. Such solid-state electrolytes 26, when in a green form or state, i.e., a non-consolidated form or state, may have an interparticle porosity 80 between the first plurality of solid-state electrolyte particles 30 that is greater than or equal to about 10 vol. % to less than or equal to about 50 vol. %, greater than or equal to 10 vol. % to less than or equal to about 40 vol. %, or greater than or equal to about 10 vol. % to less than or equal to about 30 vol. % and when processed into a working form or state, i.e., a consolidated form or state, may have an interparticle porosity 80 between the first plurality of solid-state electrolyte particles 30 that is greater than 0 vol. % to less than or equal to about 10 vol. % or greater than 0 vol. % to less than or equal to about 5 vol. %.

The first plurality of solid-state electrolyte particles 30 are sulfide and/or oxysulfide glass and glass-ceramic particles, i.e., the first plurality of solid-state electrolyte particles 30 are sulfur-based and have a glass transition temperature. A glass transition temperature is a temperature at which a glass transition occurs, and a glass transition is a reversible transition in an amorphous material from a hard and relatively brittle state into a more viscous or relatively rubbery state. Glass transitions are identifiable by an endothermic response on a differential scanning calorimetry (DSC) trace. In certain variations, the first plurality of solid-state electrolyte particles 30 may be optionally intermingled with one or more polymeric binders (not shown) and/or one or more reinforcing additives or fillers (not shown) that improve the structural integrity of the solid-state electrolyte 26. The one or more binders may be selected from the group consisting of polyvinylidene difluoride (PVDF), ethylene propylene diene monomer (EPDM) rubber, nitrile butadiene rubber (NBR), styrene-butadiene rubber (SBR), lithium polyacrylate (LiPAA), sodium polyacrylate (NaPAA), and combinations thereof. The one or more reinforcing additives or fillers may be selected from the group consisting of silica-based glass fibers, alumina fibers, boron nitride fibers, thermoplastic polymer fibers, aramid fibers, and combinations thereof. In certain variations, the solid-state electrolyte 26 may include greater than or equal to about 0 wt. % to less than or equal to about 10 wt. % of the one or more binders and/or greater than or equal to about 0 wt. % to less than or equal to about 20 wt. % of the one or more reinforcing fillers. The solid-state electrolyte 26 is discussed in more detail below with reference to the figures.

The negative electrode 22 may be formed from a lithium or sodium host material that is capable of functioning as a negative terminal of a lithium-ion battery or sodium-ion battery. For example, in certain variations, the negative electrode 22 may be defined by a plurality of negative solid-state electroactive particles 50. In certain instances, as illustrated, the negative electrode 22 is a composite comprising a mixture of the negative solid-state electroactive particles 50 and the second plurality of solid-state electrolyte particles 90. For example, the negative electrode 22 may include greater than or equal to about 10 wt. % to less than or equal to about 95 wt. %, and in certain aspects, optionally greater than or equal to about 50 wt. % to less than or equal to about 90 wt. %, of the negative solid-state electroactive particles 50 and greater than or equal to about 5 wt. % to less than or equal to about 90 wt. %, and in certain aspects, optionally greater than or equal to about 10 wt. % to less than or equal to about 40 wt. %, of the second plurality of solid-state electrolyte particles 90. Such negative electrodes 22 may have an interparticle porosity 82 between the negative solid-state electroactive particles 50 and/or the second plurality of solid-state electrolyte particles 90 that is greater than or equal to about 0 vol. % to less than or equal to about 20 vol. %. The second plurality of solid-state electrolyte particles 90 may be the same as or different from the first plurality of solid-state electrolyte particles 30.

In certain variations, the negative solid-state electroactive particles 50 may be lithium-based or sodium-based comprising, for example, a lithium or sodium alloy. In other variations, the negative solid-state electroactive particles 50 may be silicon-based comprising, for example, a silicon alloy. In still other variations, the negative electrode 22 may be a carbonaceous anode and the negative solid-state electroactive particles 50 may comprise one or more negative electroactive materials, such as graphite, graphene, and carbon nanotubes (CNTs). In still further variations, the negative electrode 22 may comprise one or more negative electroactive materials, such as lithium titanium oxide (Li₄Ti₅O₂) and sodium titanium oxide (Na₄Ti₅O₁₂); one or more metal oxides, such as V₂O₅; and metal sulfides, such as FeS.

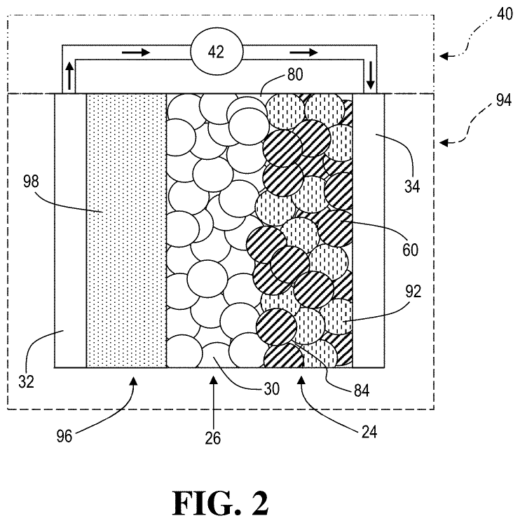

An all-solid-state (lithium or metal) metal battery 94 is shown in FIG. 2. Components of the all-solid-state metal battery 94 share reference numerals with the battery 20 that cycles lithium or sodium ions of FIG. 1. Accordingly, the all-solid-state metal battery 94 has the same positive electrode 24, i.e., cathode, and solid-state electrolyte 26 as the battery 20 that cycles ions. However, the all-solid-state metal battery 94 has a negative electrode 96, i.e., anode, comprising a solid film 98 of lithium metal or sodium metal. Therefore, the negative electrode 96 does not comprise a composite material.

Referring back to FIG. 1, in certain variations, the negative solid-state electroactive particles 50 may be optionally intermingled with one or more electrically conductive materials that provide an electron conduction path and/or at least one polymeric binder material that improves the structural integrity of the negative electrode 22. For example, the negative solid-state electroactive particles 50 may be optionally intermingled with binders, like polyvinylidene difluoride (PVDF), polytetrafluoroethylene (PTFE), ethylene propylene diene monomer (EPDM) rubber, nitrile butadiene rubber (NBR), styrene-butadiene rubber (SBR), lithium polyacrylate (LiPAA), and/or sodium polyacrylate (NaPAA) binders. Electrically conductive materials may include, for example, carbon-based materials or a conductive polymer. Carbon-based materials may include, for example, particles of graphite, acetylene black (such as KETCHEN™ black or DENKA™ black), carbon fibers and nanotubes, graphene, and the like. Examples of a conductive polymer may include polyaniline, polythiophene, polyacetylene, polypyrrole, and the like. In certain variations, conductive additives may include, for example, one or more non-carbon conductive additives selected from simple oxides (such as RuO₂, SnO₂, ZnO, Ge₂O₃), superconductive oxides (such as YBa₂Cu₃O₇, La_{0.75}Ca_{0.25}MnO₃), carbides (such as SiC₂), silicides (such as MoSi₂), and sulfides (such as CoS₂).

In certain aspects, such as when the negative electrode 22 (anode) does not include Li or Na metal, mixtures of the conductive materials may be used. For example, the negative electrode 22 may include greater than or equal to about 0 wt. % to less than or equal to about 25 wt. %, optionally greater than or equal to about 0 wt. % to less than or equal to about 10 wt. %, and in certain aspects, optionally greater than or equal to about 0 wt. % to less than or equal to about 5 wt. % of the one or more electrically conductive additives and greater than or equal to about 0 wt. % to less than or equal to about 20 wt. %, optionally greater than or equal to about 0 wt. % to less than or equal to about 10 wt. %, and in certain aspects, optionally greater than or equal to about 0 wt. % to less than or equal to about 5 wt. % of the one or more binders. The negative electrode current collector 32 may be formed from copper (Cu) or any other appropriate electrically conductive material known to those of skill in the art.

The positive electrode 24 may be formed from a lithium-based or sodium-based electroactive material that can undergo lithium/sodium intercalation and deintercalation while functioning as the positive terminal of the battery 20. For example, in certain variations, the positive electrode 24 may be defined by a plurality of positive solid-state electroactive particles 60. In certain instances, as illustrated, the positive electrode 24 is a composite comprising a mixture of the positive solid-state electroactive particles 60 and the third plurality of solid-state electrolyte particles 92. For example, the positive electrode 24 may include greater than or equal to about 10 wt. % to less than or equal to about 95 wt. %, and in certain aspects, optionally greater than or equal to about 50 wt. % to less than or equal to about 90 wt. %, of the positive solid-state electroactive particles 60 and greater than or equal to about 5 wt. % to less than or equal to about 70 wt. %, and in certain aspects, optionally greater than or equal to about 10 wt. % to less than or equal to about 30 wt. %, of the third plurality of solid-state electrolyte particles 92. Such positive electrodes 24 may have an interparticle porosity 84 between the positive solid-state electroactive particles 60 and/or the third plurality of solid-state electrolyte particles 92 that is greater than or equal to about 1 vol. % to less than or equal to about 20 vol. %, optionally greater than or equal to 5 vol. % to less than or equal to about 10 vol. %. In various instances, the third plurality of solid-state electrolyte particles 92 may be the same as or different from the first and/or second pluralities of solid-state electrolyte particles 30, 90.

In various aspects, the positive electrode 24 may be one of a layered-oxide cathode, a spinel cathode, and a polyanion cathode. For example, in the instances of a layered-oxide cathode (e.g., rock salt layered oxides), the positive solid-state electroactive particles 60 may comprise one or more positive electroactive materials selected from LiCoO₂, LiNiₓMn_{y}Co_{1-x-y}O₂ (where 0≤x≤1 and 0≤y≤1), LiNiₓMn₁₋ₓO₂ (where 0≤x≤1), and Li₁₊ₓMO₂ (where 0≤x≤1) for solid-state lithium-ion batteries or NaCoO₂, NaMnO₂, NaNiₓMn_{y}Co_{1-x-y}O₂ (where 0≤x≤1 and 0≤y≤1), NaNiₓMn₁₋ₓO₂ (where 0≤x≤1), and Na₁₊ₓMO₂ (where 0≤x≤1) for solid-state sodium-ion batteries. The spinel cathode may include one or more positive electroactive materials, such as LiMn₂O₄ and LiNiₓMn_{1.5}O₄ for lithium-ion batteries and NaMn₂O₄ and NaNiₓMn_{1.5}O₄ for sodium-ion batteries. The polyanion cation may include, for example, a phosphate such as LiFePO₄, LiVPO₄, LiV₂(PO₄)₃, Li₂FePO₄F, Li₃Fe₃(PO₄)₄, or Li₃V₂(PO₄)F₃ for lithium-ion batteries; a phosphate such as NaFePO₄, NaVPO₄, NaV₂(PO₄)₃, Na₂FePO₄F, Na₃Fe₃(PO₄)₄, or Na₃V₂(PO₄)F₃ for sodium-ion batteries; and/or a silicate such as LiFeSiO₄ or NaFeSiO₄ for lithium- or sodium-ion batteries, respectively. In this fashion, in various aspects, the positive solid-state electroactive particles 60 may comprise one or more positive electroactive materials selected from the group consisting of LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiNiₓMn_{1.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO_{4,} and combinations thereof or NaCoO₂, NaNiₓMn_{y}Co_{1-x-y}O₂ (where 0≤x≤1 and 0≤y≤1), NaNiₓMn₁₋₋ₓO₂ (where 0≤x≤1), Na₁₊ₓMO₂ (where 0≤x≤1), NaMn₂O₄, NaNiₓMn_{1.5}O₄, NaFePO_{4,} NaVPO₄, NaV₂(PO₄)₃, Na₂FePO₄F, Na₃Fe₃(PO₄)₄, Na₃V₂(PO₄)F₃, NaFeSiO₄, and combinations thereof. In certain aspects, the positive solid-state electroactive particles 60 may be coated (for example by Al₂O₃) and/or the positive electroactive material may be doped (for example by magnesium (Mg)).

In certain variations, the positive solid-state electroactive particles 60 may be optionally intermingled with one or more electrically conductive materials that provide an electron conduction path and/or at least one polymeric binder material that improves the structural integrity of the positive electrode 24. For example, the positive solid-state electroactive particles 60 may be optionally intermingled with binders, like polyvinylidene difluoride (PVDF), polytetrafluoroethylene (PTFE), ethylene propylene diene monomer (EPDM) rubber, nitrile butadiene rubber (NBR), styrene-butadiene rubber (SBR), lithium polyacrylate (LiPAA), and/or sodium polyacrylate (NaPAA) binders. Electrically conductive materials may include, for example, carbon-based materials, powdered nickel or other metal particles, or a conductive polymer. Carbon-based materials may include, for example, particles of graphite, acetylene black (such as KETCHEN™ black or DENKA™ black), carbon fibers and nanotubes, graphene, and the like. Examples of a conductive polymer may include polyaniline, polythiophene, polyacetylene, polypyrrole, and the like.

In certain aspects, mixtures of the conductive materials may be used. For example, the positive electrode 24 may include greater than or equal to about 0 wt. % to less than or equal to about 25 wt. %, optionally greater than or equal to about 0 wt. % to less than or equal to about 10 wt. %, and in certain aspects, optionally greater than or equal to about 0 wt. % to less than or equal to about 5 wt. % of the one or more electrically conductive additives and greater than or equal to about 0 wt. % to less than or equal to about 20 wt. %, optionally greater than or equal to about 0 wt. % to less than or equal to about 10 wt. %, and in certain aspects, optionally greater than or equal to about 0 wt. % to less than or equal to about 5 wt. % of the one or more binders. The positive electrode current collector 34 may be formed from aluminum (Al) or any other electrically conductive material known to those of skill in the art.

As a result of the interparticle porosity 80, 82, 84 between particles within the battery 20 (for example, the battery 20 in a green form may have a solid-state electrolyte interparticle porosity greater than or equal to about 10 vol. % to less than or equal to about 50 vol. %), direct contact between the solid-state electroactive particles 50, 60 and the pluralities of solid-state electrolyte particles 30, 90, 92 may be much lower than the contact between a liquid electrolyte and solid-state electroactive particles in comparable non-solid-state batteries. To improve contact between the solid-state electroactive particles and solid-state electrolyte particles, the amount of the solid-state electrolyte particles may be increased within the electrodes.

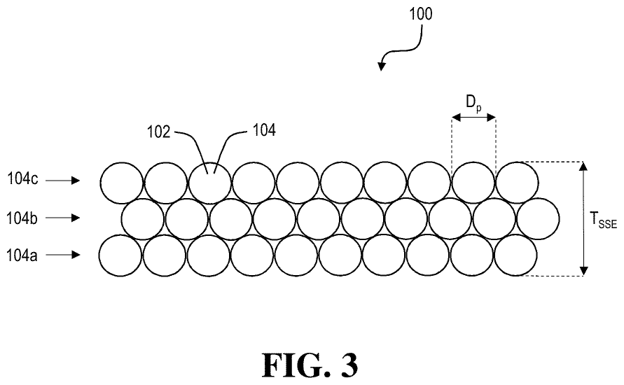

As discussed above, solid-state electrolyte particles include sulfide and/or oxysulfide glass and glass-ceramic particles, i.e., sulfur- and/or oxysulfide-based particles that have a glass transition temperature. Such solid-state electrolyte particles have an integrated molecular network in which some sulfur molecules, especially at the surfaces, are subject to react with atmospheric water and hydrolyze into toxic H₂S. Accordingly, with reference to FIG. 3, the current technology provides a solid-state electrolyte 100 that is sulfide- or oxysulfide-based and that resists hydrolysis in atmospheres having a dew point of greater than or equal to about −70° C. (equivalent to about 2.55 ppm water or a relative humidity (RH) at 70° F. of 0.0054%), or greater than about −40° C. (equivalent to about 127 ppm water or a RH at 70° C. of 0.516%). The solid-state electrolyte 100 shown in FIG. 3 includes all of the characteristics of the solid-state electrolyte 26 described with reference to FIG. 1.

As shown in FIG. 3, the solid-state electrolyte 100 of the current technology comprises a plurality of solid electrolyte particles 102. The solid electrolyte particles 102 are disposed in a plurality of layers 104a, 104b, 104c that define a three-dimensional structure. It is understood that although three layers 104a, 104b, 104c are shown in FIG. 3, the solid-state electrolyte 100 can comprise more than three layers. Also, each layer of the plurality of layers 104a, 104b, 104c is individually ordered or unordered and continuous or discontinuous. As such, in various embodiments, the solid electrolyte particles 102 are spread randomly into the three-dimensional structure. Each solid electrolyte particle 102 has a largest diameter Dₚ of greater than or equal to about 0.05 μm to less than or equal to about 50 μm or greater than or equal to about 0.1 μm to less than or equal to about 20 μm. Although each solid electrolyte particle 102 can be substantially circular, the term “diameter” in reference to each solid electrolyte particle 102 refers to a longest dimension size of each solid electrolyte particle 102. The solid-state electrolyte 100 has a thickness T_{SSE} of greater than or equal to about 1 μm to less than or equal to about 500 μm or greater than or equal to about 10 μm to less than or equal to about 200 μm.

Each solid electrolyte particle 102 is comprised of an electrolyte material 104 that results from reacting, e.g., by ball milling or melt quenching, a mixture that comprises components that generate a base glass and an oxide. Therefore, the electrolyte material 104 results from, i.e., is a reaction product of, the mixture. The base glass can be a sulfide-based base glass that includes a sulfur-containing glass modifier, a sulfur-containing glass former, an optional sulfur-containing glass co-former, and an optional glass dopant or an oxysulfide-based base glass that includes a sulfur-containing glass modifier, a sulfur-containing glass former, an oxygen-containing glass co-former, an optional sulfur-containing glass co-former, and an optional glass dopant. Because the oxide is incorporated as a glass co-modifier, the electrolyte material 104 that results from incorporating the glass co-modifier into the sulfide-based base glass or the oxysulfide-based base glass is an oxysulfide-based electrolyte material that has a glass transition. The glass co-modifier oxide is lithium oxide (for a solid-state lithium-ion battery) or sodium oxide (for a solid-state sodium-ion battery). The oxygen from the glass co-modifier results in the electrolyte material 104 being substantially resistant to humidity. The electrolyte material 104 has an integrated inorganic molecular network, in which the glass former is the primary component. The glass modifier, the glass co-formers, the glass co-modifier, and the optional glass dopant are substituted within the integrated inorganic molecular network and influence properties of the electrolyte material 104. To render the electrolyte material 104 lithium-ion-conductive, lithium must be present in the glass modifier and the glass co-modifier. Similarly, to render the electrolyte material 104 sodium-ion-conductive, sodium must be present in the glass modifier and the glass co-modifier.

As discussed above, the glass former contains sulfur and is the primary component of the integrated inorganic molecular network. As non-limiting examples, the glass former is selected from the group consisting of P₂S₅, SiS₂, GeS₂, B₂S₃, Sb₂S₅, and combinations thereof. When the electrolyte material 104 also includes a sulfur-containing glass co-former, the sulfur-containing glass co-former is also selected from the group consisting of P₂S₅, SiS₂, GeS₂, B₂S₃, Sb₂S₅, and combinations thereof. However, the glass former is present in a first concentration range and the sulfur-containing glass co-former is present in a second concentration range, wherein the second concentration range is lower than, and non-overlapping with, the first concentration range. Put another way, the glass former (or combination of glass formers) has a higher total concentration than the glass co-former (or combination of glass co-formers). Moreover, the glass former and the glass co-former do not have a material in common. For example, when the glass former comprises P₂S₅, P₂S₅ cannot also be included as a glass co-former.

As discussed above, in some embodiments, the mixture includes an oxygen-containing glass co-former. As non-limiting examples, the oxygen-containing glass co-former comprises P₂O₅, SiO₂, GeO₂, or a combination thereof.

As discussed above, the glass modifier includes sulfur and either lithium or sodium. The glass modifier is M₂S, where M is Li or Na. For example, when the solid-state electrolyte 100 conducts lithium ions, the glass modifier is Li₂S, and when the solid-state electrolyte 100 conducts sodium ions, the glass modifier is selected from the group consisting of Na₂S.

As discussed above, the glass co-modifier is an oxide selected from either lithium oxide or sodium oxide. More particularly, the glass co-modifier is an oxide, such as M₂O, where M is Li or Na. Therefore, for solid-state electrolytes that conduct lithium ions, the glass co-modifier is Li₂O, and for solid-state electrolytes that conduct sodium ions, the glass co-modifier is Na₂O.

The optional glass dopant is MX, M₃PO₄, or M₂SiO₃, where M is Li or Na, and X is a halogen (e.g., F, Cl, Br, I). For example, when the solid-state electrolyte 100 conducts lithium ions, the optional glass dopant can be selected from the group consisting of LiI, LiCl, LiBr, Li₃PO₄, Li₂SiO₃, and combinations thereof, as non-limiting examples, and when the solid-state electrolyte 100 conducts sodium ions, the optional glass dopant can be selected from the group consisting of NaI, NaCl, NaBr, Na₃PO₄, Na₂SiO₃, and combinations thereof, as non-limiting examples.

Thus, in various aspects, each particle 102 comprises a first component derived from a glass former comprising sulfur, a second component derived from a glass modifier comprising sulfur, and a third component derived from a glass co-modifier comprising lithium oxide or sodium oxide, wherein the particle 102 has a glass transition and is substantially resistant to hydrolysis. The particle 102 also optionally comprises at least one of a fourth component derived from a glass co-former comprising sulfur, a fifth component derived from a glass co-former comprising oxygen, and a sixth component derived from a glass dopant. The term “derived from” means that the particle 102 comprises components that result from various starting materials, i.e., the glass former comprising sulfur, the glass co-former comprising sulfur, the glass co-former comprising oxygen, the glass modifier, the glass co-modifier, and the glass dopant. As such, the particle 102 is a reaction product of a mixture of the starting materials.

The combination of the components for the base glass with the glass co-modifier oxide provide the oxysulfide-based electrolyte material 104. Non-limiting examples of the sulfide-based electrolyte material 104 include lithium phosphorus (oxy)sulfide, sodium phosphorus (oxy)sulfide, lithium boron (oxy)sulfide, sodium boron (oxy)sulfide, lithium boron phosphorous oxysulfide, sodium boron phosphorous oxysulfide, lithium silicon (oxy)sulfide, sodium silicon (oxy)sulfide, lithium germanium (oxy)sulfide, sodium germanium (oxy)sulfide, lithium arsenic (oxy)sulfide, sodium arsenic (oxy)sulfide, lithium selenium (oxy)sulfide, sodium selenium (oxy)sulfide, lithium antimony (oxy)sulfide, and sodium antimony (oxy)sulfide. As used herein, the term “(oxy)sulfide” refers to oxygen-free sulfide materials and oxygen-containing oxysulfide materials. As a non-limiting example, the lithium phosphorus (oxy)sulfide composition encompasses materials such as Li₂S—P₂S₅—, Li₂S—P₂S₅—P₂O₅, Li₂S—Li₂O—P₂S₅, Li₂S—Li₂O—P₂S₅—P₂O₅, and combinations thereof. Therefore, in some embodiments the solid-state electrolyte material is a sulfide-forming system with an oxide co-former (e.g., Li₂S—P₂S₅—P₂O₅).

The mixture that forms electrolyte material 104 comprises the glass former (or combination of glass formers) at a concentration of greater than or equal to about 10 mol. % to less than or equal to about 80 mol. %, such as at a concentration of about 10 mol. %, about 15 mol. %, about 20 mol. %, about 25 mol. %, about 30 mol. %, about 35 mol. %, about 40 mol. %, about 45 mol. %, about 50 mol. %, about 55 mol. %, about 60 mol. %, about 65 mol. %, about 70 mol. %, about 75 mol. %, or about 80 mol. %. The sulfur-containing glass co-former is present in the electrolyte material 104 at a concentration of greater than or equal to about 0 mol. % to less than or equal to about 30 mol. %, such as a concentration of about 0.5 mol. %, about 1 mol. %, about 2 mol. %, about 4 mol. %, about 6 mol. %, about 8 mol. %, about 10 mol. %, about 12 mol. %, about 14 mol. %, about 16 mol. %, about 18 mol. %, about 20 mol. %, about 22 mol. %, about 24 mol. %, about 26 mol. %, about 28 mol. %, or about 30 mol. %. The oxygen-containing glass co-former is present in the electrolyte material 104 at a concentration of greater than or equal to about 0 mol. % to less than or equal to about 30 mol. %, such as at a concentration of about 0.5 mol. %, about 1 mol. %, about 2 mol. %, about 4 mol. %, about 6 mol. %, about 8 mol. %, about 10 mol. %, about 12 mol. %, about 14 mol. %, about 16 mol. %, about 18 mol. %, about 20 mol. %, about 22 mol. %, about 24 mol. %, about 26 mol. %, about 28 mol. %, or about 30 mol. %. The glass modifier (or combination of glass modifiers) is present in the electrolyte material 104 at a concentration of greater than or equal to about 15 mol. % to less than or equal to about 80 mol. %, such as at a concentration of about 15 mol. %, about 20 mol. %, about 25 mol. %, about 30 mol. %, about 35 mol. %, about 40 mol. %, about 45 mol. %, about 50 mol. %, about 55 mol. %, about 60 mol. %, about 65 mol. %, about 70 mol. %, about 75 mol. %, or about 80 mol. %. The glass co-modifier (or combination of glass co-modifiers) is present in the electrolyte material 104 at a concentration of greater than 0 mol. % to less than or equal to about 20 mol. %, such as at a concentration of about 0.5 mol. %, about 1 mol. %, about 2 mol. %, about 4 mol. %, about 6 mol. %, about 8 mol. %, about 10 mol. %, about 12 mol. %, about 14 mol. %, about 16 mol. %, about 18 mol. %, or about 20 mol. %. The optional glass dopant (or combination of glass dopants) is present in the electrolyte material 104 at a concentration of greater than or equal to about 0 mol. % to less than or equal to about 40 mol. %, such as at a concentration of 0 mol. % (i.e., not present), about 1 mol. %, about 5 mol. %, about 10 mol. %, about 15 mol. %, about 20 mol. %, about 25 mol. %, about 30 mol. %, about 35 mol. %, or about 40 mol. %.

As such, the electrolyte material can have the formula GFₐSGCF_{b}OGCF_{c}GMₓGCM_{y}GD_{z}, where GF=glass former(s), SGCF=sulfur-containing glass co-former, OGCF=oxygen-containing glass co-former, GM=glass modifier(s), GCM=glass co-modifier(s), and GD=glass dopant(s), and where 10≤a≤80, 0≤b≤30, 0≤c≤30, 15≤x≤80, 0≤y≤20, 0≤z≤40,and a+b+c+x+y+z=100. Therefore, when the base glass is a sulfide-based base glass, the mixture comprises GFₐSGCF_{b}GMₓGCM_{y}GD_{z}, where 10≤a≤80, 0<b≤30, 15≤x≤80, 0<y≤20, 0≤z≤40, and a+b+x+y+z=100 and when the base glass is an oxysulfide-based base glass, the mixture comprises GFₐSGCF_{b}OGCF_{c}GMₓGCM_{y}GD_{z}, where 10≤a≤80, 0≤b≤30, 0<c≤30, 15≤x≤80, 0<y≤20, 0≤z≤40, a+b+x+y+z=100, and a+b+c+x+y+z=100. In one embodiment, the electrolyte material 104 comprises (Li₂O)_{z(100-y)}(Li₂S)_{(0.7-z)(100-y)}(P₂S₅)_{(0.3-x)(100-y)}(P₂O₅)_{x(100-y)}(LiM)_{y}, where M is Cl, Br, or I, 0<x<0.1, 0<y<30, and 0<z<0.1. In some embodiments, the electrolyte material 104 further includes a precipitated sulfide crystal phase depending on the chemistry of the electrolyte material 104, such as Li₇P₃S_{11-X}O_{X} (0≤x≤2.5), Li₁₀P₂MS₁₂ (M=Ge, Sn, Si), Li₃PS₄, Li₇P₂S₈I, and Li₆PS₅X (X═Cl, Br, I, BH₄), as non-limiting examples.

In one aspect of the current technology, ion-conducting ceramic phases are precipitated from a glass with the glass co-modifier (lithium oxide or sodium oxide) to form a glass-ceramic. In some embodiments, O is incorporated into a ceramic phase isostructurally with S. As a non-limiting example, (Li₂O)ₓ(Li₂S)₇₀₋ₓ(P₂S₅)₃₀ glass can yield a Li₇P₃S₍₁₁₋ₓ₎Oₓ ceramic phase. In other embodiments, O is segregated from a ceramic phase composition and only contained in a glassy matrix. In yet other embodiments, the glass is devitrified into a separate oxide-containing ceramic and/or a separate sulfide-containing ceramic.

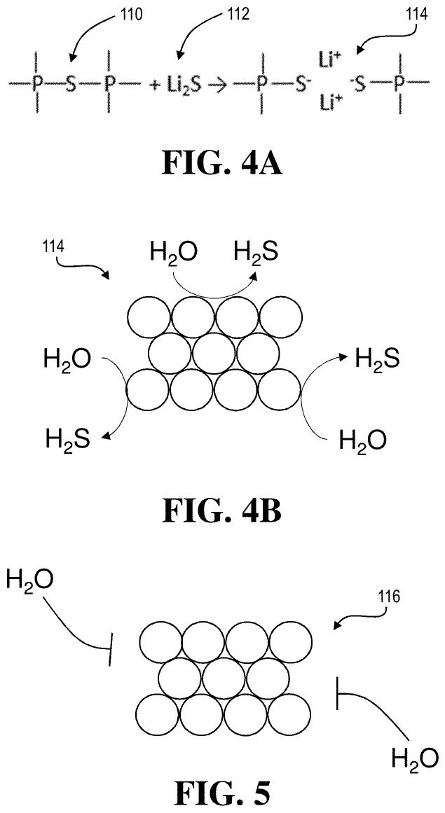

As discussed above, both of the glass former and the glass modifier comprises sulfur. As an example, FIG. 4A shows a glass former 110 combined with a glass modifier 112 to form a solid-state electrolyte material 114 that conducts lithium ions. The solid-state electrolyte material 114 comprises P atoms that are covalently bound to S atoms derived from the glass former 110 or glass modifier 112. FIG. 4B shows an illustration of the solid-state electrolyte material 114. As shown in FIG. 4B, atmospheric water reacts with the sulfur in the solid-state electrolyte material and generates toxic H₂₅ in a hydrolysis reaction. More particularly, H₂O attacks labile bridging sulfur groups, such as P—S—P and Si—S—Si, to produce P—OH and/or Si—OH groups in glass, while releasing the toxic H₂S. FIG. 5 shows an illustration of a second solid-state electrolyte material 116. The second solid-state electrolyte material 116 is the same as the solid-state electrolyte material 114 in FIGS. 4A and 4B, but further includes the glass co-modifier, which, for the exemplary solid-state electrolyte material 114 that conducts lithium ions, is lithium oxide. Here, the second solid-state electrolyte material 116 has an integrated molecular network that comprises P atoms (derived from the glass former 110) covalently bound to O atoms derived from the oxide. Thus, the glass co-modifier replaces at least a portion of the S atoms in the second solid-state electrolyte material 116 with O atoms, which are not reactive with atmospheric water. Therefore, the second solid-state electrolyte material, which is in accordance with the current technology, inhibits and resists hydrolysis. For this reason, solid-state electrolytes of the current technology can be handled and worked upon in an atmosphere containing more water than an atmosphere that is appropriate for (oxy)sulfide solid-state electrolytes that do not include the glass co-modifier. Table 1 below shows the humidity in various atmospheres. Without the glass co-modifier, a solid-state electrolyte should be worked upon or handled in an inert glovebox so that hydrolysis may be avoided. However, the solid-state electrolyte of the current technology is substantially resistant to hydrolysis in an atmosphere having a dew point of greater than or equal to about −90° C. (about 0.1 ppm H₂O and a relative humidity at 70° C. of 0.00037%) or greater than or equal to about −70° C. (2.55 ppm H₂O and a relative humidity at 70° C. of 0.0054%). In various embodiments, the solid-state electrolyte is substantially resistant to hydrolysis in an atmosphere having a dew point of less than or equal to about −35° C. or higher. By “substantially resistant to hydrolysis” it is meant that an ionic conductivity of the solid-state electrolyte decreases by less than about 15% when exposed to a dew point of about −70° C. for a time period of about 30 minutes, by less than about 30% when exposed to a dew point of about −60° C. for a time period of about 30 minutes, by less than about 40% when exposed to a dew point of about −50° C. for a time period of about 30 minutes, or by less than about 80% when exposed to a dew point of about −40° C. for a time period of about 30 minutes,. As such, the solid-state electrolyte of the current technology that includes the glass co-modifier can be worked upon or handled at humidities above that of an inert glovebox, such as in a −70 dew point dry room or a −40° C. dew point dry room. Put another way, the solid-state electrolyte of the current technology is more resistant to hydrolysis than another solid-state electrolyte having the exact same composition (including starting materials and their respective concentrations), but that does not include the glass co-modifier.

TABLE 1
Humidity present in various atmospheres.

| | | % Relative | |
|---|---|---|---|
| Dew point | PPM | Humidity at | |
| (° C.) | H₂O | 70° F. | Atmosphere |
| −90 | ~0.1 | 0.00037 | Inert glovebox |
| −70 | 2.55 | 0.0054 | Dry room |
| −40 | 127 | 0.516 | Dry room |
| 2 | 6970 | 28.2 | Ambient air |

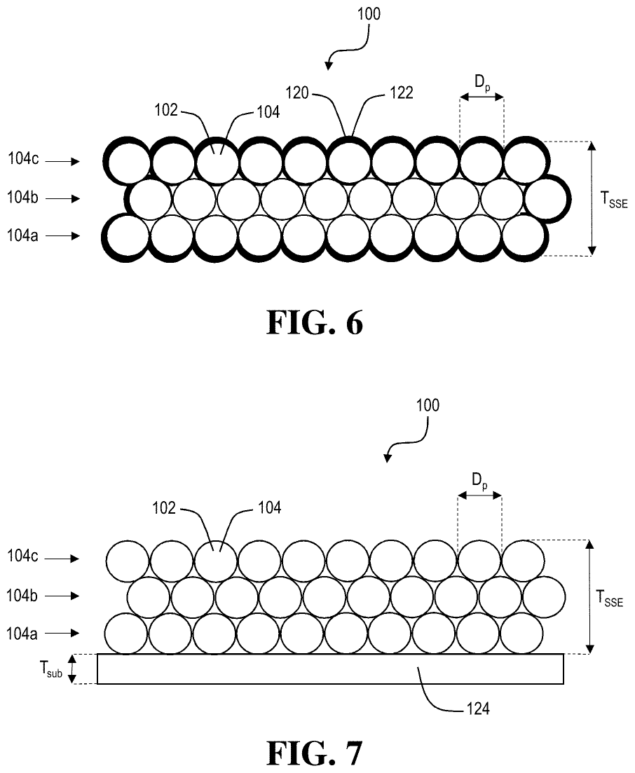

With renewed reference to FIG. 3, in order to provide yet further protection against hydrolysis, in some embodiments, the solid electrolyte particles 102 of the solid-state electrolyte 100 are covered by a protective coating. Such an embodiment is represented in FIG. 6, which shows the solid-state electrolyte 100 shown in FIG. 3, but which further includes a sacrificial coating layer 120, which is also referred to herein as a “sacrificial binder” or a “thermally removable protective sacrificial binder layer.” A description of the sacrificial binder is also provided in U.S. patent application Ser. No. 16/438,590, filed on Jun. 12, 2019, which is incorporated herein by reference in its entirety. The sacrificial binder 120 is an interconnected web applied and dispersed through and around the solid electrolyte particles 102 such that all or substantially all of the solid electrolyte particles 102 are coated with an exterior layer 122 of the sacrificial binder 120. By “substantially all of the solid electrolyte particles 102” it is meant that greater than or equal to about 80% or greater than or equal to about 90% of the solid electrolyte particles 102 are coated by the exterior layer 122. Accordingly, the exterior layer 122 can be continuous and coat each and every solid electrolyte particle 102, or it can be discontinuous and coat substantially all of the solid electrolyte particles 102. The sacrificial binder 120 further protects the solid-state electrolyte 100 from hydrolysis and is removed when the solid-state electrolyte 100 in green form is processed and consolidated into a working form.

The sacrificial binder 120 is a water-resistant organic polymer that is removable by, for example, hot pressing. In some embodiments, the polymer is thermally decomposable and/or volatilizable at a temperature of less than or equal to about 200° C. These polymers allow the sacrificial binder 120 to be removed as a decomposition product from the solid-state electrolyte 100 before it is processed and consolidated into its final working form, which may occur prior to or while the solid-state electrolyte 100 is assembled with other companion battery layers (e.g., cathode, anode, current collectors, etc.) without unintentionally devitrifying the electrolyte material 104 of the solid electrolyte particles 102 or otherwise thermally affecting the solid-state electrolyte 100 in an unintended manner. After the removal of the sacrificial binder 120, the solid-state electrolyte 100 is substantially free of any carbon residue (which may be electrically conductive) left behind by the organic polymer. Removal of carbon residues requires burning, which can be damaging to the solid-state electrolyte or other battery components. By “substantially free of any carbon residue,” it is meant that the solid-state electrolyte 100 comprises less than or equal to about 5 wt. % or less than or equal to about 1 wt. % of carbon residue, such that any carbon residue present does not affect the ability of the solid-state electrolyte to conduct ions. In some embodiments, the organic polymer of the sacrificial binder 120 is poly(propylene carbonate) (PPC), which thermally decomposes into liquids and gases and has a high vapor pressure (about 0.03 mmHg at 25° C.). Formula (I) below shows the molecular structure of PPC.

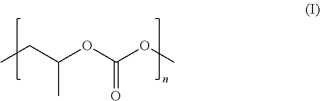

Organic polymers that volatilize at less than or equal to about 200° C. are also useful as the sacrificial binder 120 because they can be removed by evaporation before the solid-state electrolyte 100 is processed and consolidated. Other volatilizable organic polymers that can be used in the sacrificial binder 120 include thermoplastic resins. Waxes, such as paraffin wax; oils, such as mineral oil, vegetable oil, and paraffin oil; and combinations of waxes and/or oils can also be used.

The solid-state electrolyte 100 shown in FIGS. 3 and 6 can be isolated, as shown in FIGS. 3 and 6, or it can be supported on a substrate. FIG. 7 shows the same solid-state electrolyte 100 shown in FIG. 3 supported by a substrate 124, which is removable in various embodiments so that the solid-state electrolyte 100 can be transferred to another battery component during battery fabrication. Although not shown in FIG. 7, the solid-state electrolyte 100 comprises the sacrificial binder 120 shown in FIG. 6 in some embodiments. The substrate 124 comprises a plastic, such as a polyimide (e.g., poly(4,4′-oxydiphenylene-pyromellitimide, available under the tradename KAPTON®) or a polyolefin (e.g., polyethylene or polypropylene), and has a thickness T_{sub} of greater than or equal to about 10 μm to less than or equal to about The solid-state electrolyte 100 in green form can be processed and consolidated into a working form while coupled to the substrate 124 or after the solid-state electrolyte 100 has been removed from the substrate 124. In some embodiments, the substrate 124 is a battery component, such as a cathode or an anode. As discussed above, any of the solid-state electrolytes described herein can be incorporated into a solid-battery.

The current technology also provided a method of fabricating the solid-state electrolyte described above. The method comprises combining a plurality of particles into a solvent to form a slurry. The plurality of particles and the solvent are combined in a particle:solvent ratio of from about 1:10 to about 10:1, including a ratio of about 1:1. However, it is understood that the particle:solvent ratio depends on the solvent and is adjusted so that the slurry can be handled without great difficulty and so that it contains a sufficient volume of particles to form the solid-state electrolyte. Each particle of the plurality comprises a glass former, a glass modifier, and an oxide (glass co-modifier) as described above. Each particle of the plurality can also include an optional glass co-former and/or an optional glass dopant. The solvent is aprotic and has a kinematic viscosity of less than or equal to about 0.3 mPa·s, which ensures that the particles and any intermediates and/or products are not solubilized. The solvent can be an aromatic, a saturated hydrocarbon, or an unsaturated hydrocarbon. Non-limiting examples of the solvent include methoxybenzene (anisole), dichloromethane, tetrahydrofuran (THF), ethyl acetate, diethyl ether, methylene chloride, carbon tetrachloride, chloroform, toluene, benzene, cyclohexane, hexane, pentane, and combinations thereof. A person having ordinary skill in the art understands that solubility is glass-dependent and could determine if the particles and intermediates and/or products can be solubilized by a solvent, for example, by a solubility test. Because the plurality of particles includes the oxide, the method is performed in an atmosphere having a dew point of greater than or equal to about −70° C. (equivalent to 2.55 ppm H₂O and a relative humidity at 70° C. of 0.0054%) or greater than or equal to about −40° C. (equivalent to 127 ppm H₂O and a relative humidity at 70° C. of 0.516%), such as in an about −70 dew point dry room or an about −40° C. dew point dry room.

The plurality of particles is generated by combining glass former powder, glass modifier powder, glass co-modifier powder, and, optionally, glass co-former powder and/or glass dopant powder together at concentrations discussed above to form a mixture and subjecting the mixture to ball milling or melt quenching. Ball milling is performed by transferring the mixture, grinding media, and, optionally, a milling solvent, into a cylindrical drum and rotating the cylindrical drum about its longitudinal axis. Because the milling solvent is optional, the contents of the cylindrical drum can be dry (when there is no milling solvent) or wet (when there is a solvent). When present, the solvent prevents agglomeration of the powders, which facilitates mechanochemical reactions. Ball milling is complete when the plurality of particles has formed, which depends on the drum radius, rotation speed, amount of grinding media, and milling solvent volume and viscosity, when used. Melt quenching is performed by melting the mixture in a furnace having a temperature of greater than or equal to about 800° C. to form a melt and rapidly quenching the melt through its supercooled liquid state to a temperature below its glass transition temperature into a flattened ribbon of amorphous solid material. The flattened ribbon of amorphous solid material can be annealed at a temperature of greater than or equal to about 100° C. to less than or equal to about 350° C. to remove internal stresses and optionally heated to induce crystallization. The solid material can then be ball milled as described above. The particles can be made by other methods as well, such as those described in U.S. Patent Publication No. 2018/0294517, which is incorporated herein by reference in its entirety.

The method also comprises applying the slurry to a substrate, such as a plastic or a battery component (i.e., a cathode, an anode, etc.) and then removing the solvent from the slurry to form the solid-state electrolyte in a green state. Removing the solvent from the slurry is performed by heating the slurry to a temperature of greater than or equal to about 20° C. to less than or equal to about 100° C. A negative pressure, i.e., a vacuum, can be applied to the slurry to help facilitate solvent removal. Removing the solvent yields the solid-state electrolyte material in a green form or state.

In some embodiments, the slurry also includes a permanent binder to help hold the particles together when the solid-state electrolyte is in the green form. Non-limiting examples of the permanent binder include polyvinylidene fluoride (PVDF), an ethylene propylene diene monomer (EPDM) rubber, styrene butadiene rubber (SBR), polyacrylic acid, or a combination thereof

When the solid-state electrolyte in green form is generated on a plastic substrate, it can be removed from the substrate and disposed between a cathode and an anode to form a green solid-state battery. When the solid-state electrolyte in green form is generated on substrate that is a battery component, the remainder of the battery can be assembled to form a green solid-state battery. For example, if the slurry was applied onto a cathode, then an anode can be disposed over the solid-state electrolyte to form the green solid-state battery. Alternatively, if the slurry was applied onto an anode, then an cathode can be disposed over the solid-state electrolyte to form the green solid-state battery.

In various embodiments, the method further comprises processing the solid-state electrolyte (or green solid-state battery) to generate a working, consolidated form (or battery) from the green state. In some embodiments, the processing comprises cold pressing the solid-state electrolyte in the green state between a pair of unheated platens to reduce the interparticle porosity. In other embodiments, the processing comprises hot pressing the solid-state electrolyte in the green state between a pair of platens heated to a temperature of greater than or equal to about 100° C. to less than or equal to about 350° C. to reduce the interparticle porosity. In yet other embodiments, the processing comprises calendaring the solid-state electrolyte in the green state by feeding it between a pair of counter-rotating rollers that are heated to a temperature of greater than or equal to about 100° C. to less than or equal to about 350° C. A pressure of greater than or equal to about 1 MPa to less than or equal to about 200 MPa is applied to the green solid-state electrolyte by the platens or rollers. When heating by hot pressing or calendaring, the particles within the solid-state electrolyte are sintered or undergo viscoplastic flow, which causes the particles to merge into each other and form a more unitary structure, having undefined, or at least less-defined, particle boundaries. Therefore, the solid-state electrolyte can be processed alone or in combination with other battery components.

When the solid-state electrolyte includes the sacrificial binder, the binder can be dissolved in organic solvent to form a binder solution. The binder solution is then applied over all exposed surfaces of the solid-state electrolyte in the green form or state. The solvent is then removed as provided above. Here, the sacrificial binder encapsulates all exposed portions of the solid-state electrolyte. Alternatively, the sacrificial binder can be included in the slurry described above, in which case, the binder encapsulates the solid-state electrolyte after the solvent is removed from the slurry.

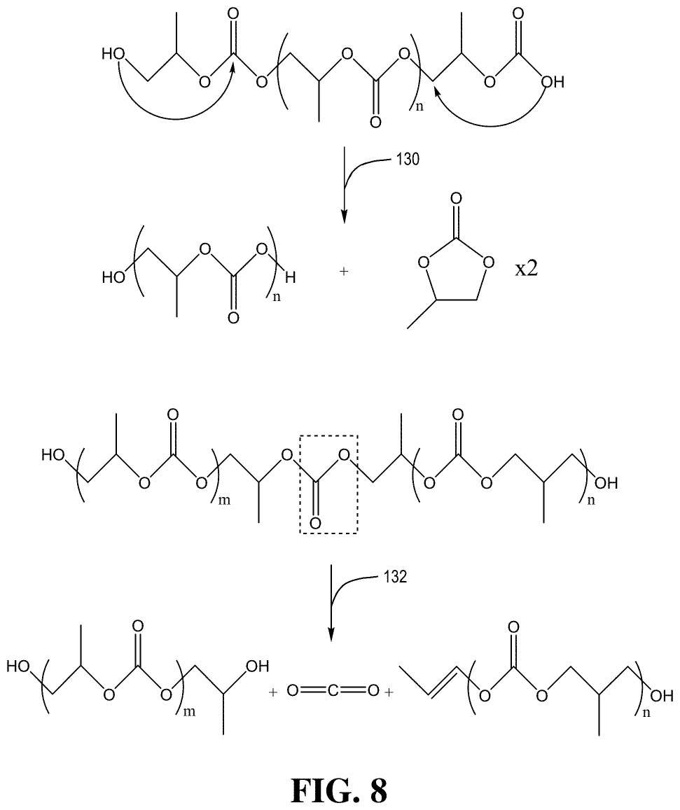

The sacrificial binder is removed by thermal decomposition or volatilization of the solid-state electrolyte in green form by applying at least one of heat or subatmospheric pressure to the solid-state electrolyte. For example, when the sacrificial binder includes PPC, the solid-state electrolyte is heated to a temperature greater than or equal to about 200° C. to less than or equal to about 250° C. because the onset of thermal decomposition of PPC is between 180° C. and 240° C. The solid-state electrolyte can be heated alone or together with other battery components. When heated to its thermal decomposition temperature, the PPC decomposes by polymer unzipping and by random chain scission. This thermal decomposition of PPC is shown in FIG. 8. During a polymer unzipping reaction 130, thermal energy activates the ends of polymer chains, causing an alkoxide backbiting reaction (left side) or a carbonate backbiting reaction (right side), depending on how the PPC polymer chains are terminated. In each case, a nucleophile (a carboxylate nucleophile in the alkoxide backbiting reaction or an alcohol end-group nucleophile in the carbonate backbiting reaction) attacks an electrophilic carbon atom in the polymer backbone. This attack causes the polymer degradation and the production of cyclic propylene carbonate. In a random chain scission reaction 132, C═O bonds in the polymer backbone undergo thermally-induced cleavage to generate carbon dioxide and acetone as products. The cyclic propylene carbonate, carbon dioxide, and acetone are easily removed from the solid-state electrolyte, which remains substantially free of carbon residues. Further details for incorporating the sacrificial binder into the solid-state electrolyte are provided in U.S. patent application Ser. No. 16/438,590, filed on Jun. 12, 2019, which is incorporated herein by reference in its entirety.

Embodiments of the present technology are further illustrated through the following non-limiting examples.

### EXAMPLE 1

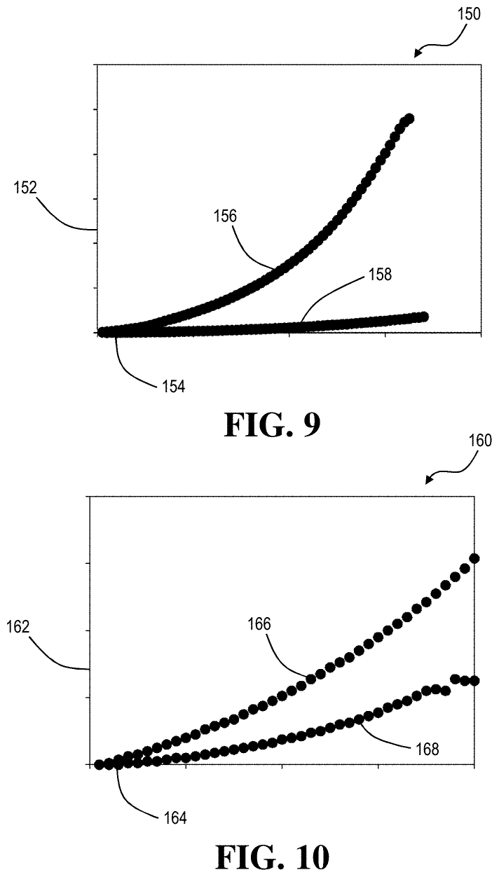

A solid-state electrolyte control without a glass co-modifier is compared to a solid-state electrolyte having a glass co-modifier according to the current technology. Control particles are generated by ball milling the glass formers P₂S₅ and P₂O₅ with the glass modifier Li₂S and include (Li₂S)₇₀(P₂S₅)₂₅(P₂O₅)₅ as a result of the ball milling. The solid-state electrolyte particles are generated by ball milling the glass former P₂S₅ with the glass modifier Li₂S and the glass co-modifier Li₂O and include (Li₂O)₇(Li₂S)₆₃(P₂S₅)₃₀ as a result of the ball milling. The particles are processed into solid-state electrolyte layers in a 300 L glovebox by suspending in a solvent, casting, and removing the solvent. The solid-state electrolyte control and the solid-state electrolyte are then exposed to ambient air having a dew point of 37° F. (equivalent to about 4700 ppm H₂O and a relative humidity at 70° F. of about 30%) for about 70 minutes. Results are displayed in a graph 150 shown in FIG. 9. The graph 150 has a y-axis 152 representing H₂S concentration (cc gas/g solid-state electrolyte) and an x-axis 154 representing time (minutes). A curve for the control 156 and a curve for the solid-state electrolyte 158 (according to the current technology) are provided in the graph 150. The results show that after about 60 minutes of exposure to the ambient air, the solid-state electrolyte generates about tenfold less toxic H₂S than the control.

### EXAMPLE 2

A solid-state electrolyte control without a glass co-modifier is compared to a solid-state electrolyte having a glass co-modifier according to the current technology. Control particles are generated by melt quenching the glass formers P₂S₅ and SiS₂ with the glass modifier Li₂S and include (Li₂S)₆₀(SiS₂)₂₈(P₂S₅)₁₂ as a result of the melt quenching. The solid-state electrolyte particles are generated by ball milling the glass formers P₂S₅ and SiS₂ with the glass modifier Li₂S and the glass co-modifier Li₂O and include (Li₂O)₇(Li₂S)₅₀(SiS₂)₃₅(P₂S₅)₈ as a result of the ball milling. The particles are processed into solid-state electrolyte layers in a 300 L glovebox by suspending in a solvent, casting, and removing the solvent. The solid-state electrolyte control and the solid-state electrolyte are then exposed to ambient air having a dew point of 37° F. (equivalent to about 4700 ppm H₂O and a relative humidity at 70° F. of about 30%) for about 40 minutes. Results are displayed in a graph 160 shown in FIG. 10. The graph 160 has a y-axis 162 representing H₂S concentration (cc gas/g solid-state electrolyte) and an x-axis 164 representing time (minutes). A curve for the control 166 and a curve for the solid-state electrolyte 168 (according to the current technology) are provided in the graph 160. The results show that after about 40 minutes of exposure to the ambient air, the solid-state electrolyte generates about threefold less toxic H₂S than the control.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A solid-state electrolyte comprising an integrated molecular network resulting from a mixture comprising:
a glass former comprising sulfur;
a glass co-former comprising sulfur;
a glass modifier comprising sulfur; and
a glass co-modifier comprising an oxide,
wherein the solid-state electrolyte is substantially resistant to hydrolysis in an atmosphere having a dew point of greater than about −90° C.

2. The solid-state electrolyte according to claim 1, wherein the solid-state electrolyte has a glass transition.

3. The solid-state electrolyte according to claim 1, wherein:
the glass former is present in a first concentration range;
the glass co-former is present in a second concentration range that is lower than, and non-overlapping with, the first concentration range;
the glass former and the glass co-former comprise a material individually selected from the group consisting of P₂S₅, SiS₂, GeS₂, B₂S₃, Sb₂S₅, and combinations thereof; and
the glass former and the glass co-former do not have a material in common.

4. The solid-state electrolyte according to claim 3, wherein the mixture further comprises a glass dopant selected from the group consisting of MX, M₃PO₄, M₂SiO₃, and combinations thereof, where M is Li or Na, and X is a halogen.

5. The solid-state electrolyte according to claim 1, wherein:
the glass former is selected from the group consisting of P₂S₅, SiS₂, GeS₂, B₂S₃, Sb₂S₅, and combinations thereof; and
the mixture further comprises a glass co-former selected from the group consisting of P₂O5, SiO₂, GeO₂, and combinations thereof.

6. The solid-state electrolyte according to claim 5, wherein the mixture further comprises a glass dopant selected from the group consisting of MX, M₃PO₄, M₂SiO₃, and combinations thereof, where M is Li or Na, and X is a halogen.

7. The solid-state electrolyte according to claim 1, wherein the glass modifier is M2S, where M is Li or Na.

8. The solid-state electrolyte according to claim 1, wherein the glass co-modifier comprises M₂O, where M is Li or Na.

9. The solid-state electrolyte according to claim 1, wherein the solid-state electrolyte is in a green form having an interparticle porosity of greater than or equal to about 10 vol. % to less than or equal to about 50 vol. %.

10. The solid-state electrolyte according to claim 9, wherein the integrated molecular network is coated with a thermally removable protective sacrificial binder layer.

11. The solid-state electrolyte according to claim 1, wherein the solid-state electrolyte is in a consolidated working form having an interparticle porosity of greater than 0 vol. % to less than or equal to about 10 vol. %.

12. The solid-state electrolyte according to claim 1, wherein the solid-state electrolyte is incorporated into a solid-state battery.

13. A particle comprising:
a first component derived from a glass former comprising sulfur;
a second component derived from a glass co-former comprising sulfur;
a third component derived from a glass modifier comprising sulfur; and
a fourth component derived from a glass co-modifier comprising lithium oxide or sodium oxide,
wherein the particle has a glass transition, and
wherein the particle is substantially resistant to hydrolysis in an atmosphere having a dew point of greater than about −70° C.

14. The particle according to claim 13, wherein:
the glass former and the glass co-former comprise a material individually selected from the group consisting of P₂S_{5,} SiS2, GeS2, B2S3, Sb2S_{5,} and combinations thereof, the glass former and the glass co-former not having a material in common, and the glass former having a higher concentration that the glass co-former;
the glass modifier is M₂S, where M is Li or Na; and
the glass co-modifier comprises M₂O, where M is Li or Na.

15. The particle according to claim 13, further comprising:
a fifth component derived from a glass dopant selected from the group consisting of MX, M₃PO₄, M₂SiO₃, and combinations thereof, where M is Li or Na, and X is a halogen.

16. A method of fabricating a solid-state electrolyte, the method comprising:
combining a plurality of particles resulting from ball milling or melt quenching a mixture comprising a glass former comprising sulfur, a glass modifier comprising sulfur, and a glass co-modifier comprising lithium oxide or a sodium oxide in a solvent to form a slurry; and
removing the solvent from the slurry to form the solid-state electrolyte in a green state,
wherein the method is performed in an atmosphere having a dew point of greater than or equal to about −70° C.

17. The method according to claim 16, wherein the removing the solvent from the slurry comprises heating the slurry to a temperature of greater than or equal to about 20° C. to less than or equal to about 100° C. and optionally applying a negative pressure to the slurry.

18. The method according to claim 16, wherein the solvent is aprotic and has a kinematic viscosity of less than or equal to about 0.3 mPa·s.

19. The method according to claim 16, further comprising hot pressing the solid-state electrolyte in the green state at a temperature of greater than or equal to about 100° C. to less than or equal to about 350° C. to convert the solid-state electrolyte from the green state to a working state having a porosity of less than or equal to about 10%.

20. The method according to claim 19, wherein prior to the hot pressing, the solid-state electrolyte in the green state is disposed between a cathode and an anode.
